(19) United States
(12) Patent Application Publication
(10) Pub. No.: US 2006/0018577 A1
(43) Pub. Date: Jan. 26, 2006

(54) Apparatus for forming an extended nip

(75) Inventors: Wolfgang Mark, Meerbusch (DE); Ralf Gross, Tonisvorst (DE); Axel Hohne, Moers (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Eduard Kusters Maschinenfabrik GmbH & Co. KG, Krefeld (DE)

(21) Appl. No.: 11/180,119

(22) Filed: Jul. 12, 2005

(30) Foreign Application Priority Data
Jul. 20, 2004 (DE) 10 2004 035 092.2
Sep. 1, 2004 (DE) 10 2004 013 639.2

(51) Int. Cl. F16C 23/00

(52) U.S. Cl. 384/256; 492/26

(57) ABSTRACT

Apparatus for forming an extended nip between a mating roll and a shoe roll for treating a product web, in particular a paper web, the shoe roll having a stationary support and a flexible roll cover which can rotate around the beam and which, in the region of the extended nip, is supported on a pressure shoe arranged on the support and whose ends are fixed on both sides in antifriction-mounted rim discs which are mounted via axially displaceable bearing rings on bearing sleeves fixed to the supporting element, bearing sleeve and bearing rings in each case forming an axially and double-acting cylinder/piston unit, whose pressure chambers are connected to pressure lines for an ability to move the bearing rings axially when pressure medium is applied.

### BACKGROUND OF THE INVENTION

The invention relates to an apparatus for forming an extended nip between a mating roll and a shoe roll for treating a product web.

Devices of this type with a shoe roll having a pressing section for treating a product web, in particular for dewatering and/or calendering a paper web, are known. DE 33 17 455 discloses a pressing device for dewatering a paper web in which a tubular flexible roll cover runs around a stationary supporting element constructed as a hollow frame. The roll cover can be pressed onto part of the circumference of a mating roll with the aid of a press shoe, by which means an extended nip extended in the running direction of the roll cover is formed. In order to tension the roll cover in the axial direction, each of its ends is fixed to a rotatable rim disc. The latter rests via anti-friction bearings on a bearing ring, which rests on a bearing sleeve such that it can be displaced axially but not rotated. This bearing sleeve is fixed to the supporting element. Compression springs effect displacement of the bearing ring outwards and thus tensioning of the roll cover.

In order to increase the lifetime of the roll cover, it is also known, from EP 0 527 881 B1, to displace the roll cover axially with respect to the press shoe after a specific operating period. Such a displacement is sufficient to move the respectively fatigued region of the roll cover away from the axial rim region of the press shoe. The displacement of the roll cover is carried out at a stationary roll cover end, while the respective other roll cover end is self-positioning and therefore automatically follows an axial displacement at the stationary roll cover end. The displacement and roll cover tensioning are achieved by additional elements in the form of incorporated cylinders. These additional elements not only hamper the design construction but also necessitate additional maintenance work.

It is therefore on object of the invention to provide a device for forming an extended nip which, without additional elements, permits axial tensioning and movement of the roll cover in order to increase its lifetime.

This object is achieved by the features of Claim 1.

By this means, an apparatus for forming an extended nip is provided in which an inner part of a rim disc is constructed as a cylinder/piston unit. Via a pressure medium supply, the pressure chambers of the double-acting cylinder/piston unit can be supplied with pressure medium and, in this way, the rim discs can be moved. The tensioning of the roll cover and also an axial displacement of the same with respect to the press shoe can be carried out with the same functional unit in the form of an integrated cylinder/piston unit.

In this case, the piston of the cylinder/piston unit can be formed by an extension of the bearing sleeve extending radially, while the cylinder can be formed by an annular chamber in the bearing ring. The pressure lines are preferably led into the pressure chambers via the piston, in order to set an advantageous pressure medium flow. Displacement of the roll cover by means of the cylinder/piston unit can be carried out in discrete steps or in any desired positions.

In order to lock a stationary rim disc, an additional latching means can be provided.

For the purpose of damping and also for braking the movement of the roll cover, the bearing rings can be designed such that they can be displaced counter to a spring prestress.

The displacement path of the bearing ring located outside the roll cover can be enclosed by a bellows. As a result, contamination is reduced, which means that the expenditure on maintenance is reduced.

Further refinements of the invention can be gathered from the following description and the dependent claims.

### BRIEF DESCRIPTION OF THE DRAWINGS

The invention will be explained in more detail below by using the exemplary embodiment of the invention illustrated in the appended figures, in which:

FIG. 1 shows, schematically and partly in section, a side view of a device for forming an extended nip,

FIG. 2 shows, enlarged, a partial longitudinal section of a device for forming an extended nip according to the invention in the region of a rim disc unit of one roll cover end according to a first exemplary embodiment,

FIG. 3 shows, enlarged, a partial longitudinal section of a device for forming an extended nip according to the invention in the region of a rim disc unit of the other roll cover end as compared with FIG. 2,

FIG. 4 shows a partial longitudinal section of a device for forming an extended nip according to the invention in the region of a rim disc unit of the other roll cover end according to a second exemplary embodiment.

### DETAILED DESCRIPTION OF THE INVENTION

The invention relates to an apparatus for forming an extended nip between a shoe roll 1 and a driven mating roll 2, which interact in an extended nip 3 for treating a product web, in particular a paper web, it being possible for the device to be part of a paper production plant.

The shoe roll 1 comprises a stationary support 4 and a roll cover 5 which can be rotated about the support 4 and which consists of a flexible material, for example rubber or plastic. The roll cover 5 is constructed in the form of a hose and, at the ends, is fixed to rim discs 6, 7 which are seated rotatably on the support 4, in order to form a closed shoe roll 1. An interspace 8 between support 4 and roll cover 5 is preferably supplied with compressed air in order to obtain a cylindrical shape.

Provided on the support 4 is a pressure shoe 9 which, together with the mating roll 2, delimits the extended nip 3. The pressure shoe 9 is supported on the support 4 via a supporting bar comprising a plurality of hydraulic supporting elements 10 arranged spaced apart axially from one another.

The support 4 has roll journals 11, 12, which are mounted in a machine frame 13, 14. The rotatable rim discs 6, 7 rest via anti-friction bearings 15, 16 on a bearing ring 17, 18, which is seated on the support 4. According to the present invention, these rim disc units are constructed as follows.

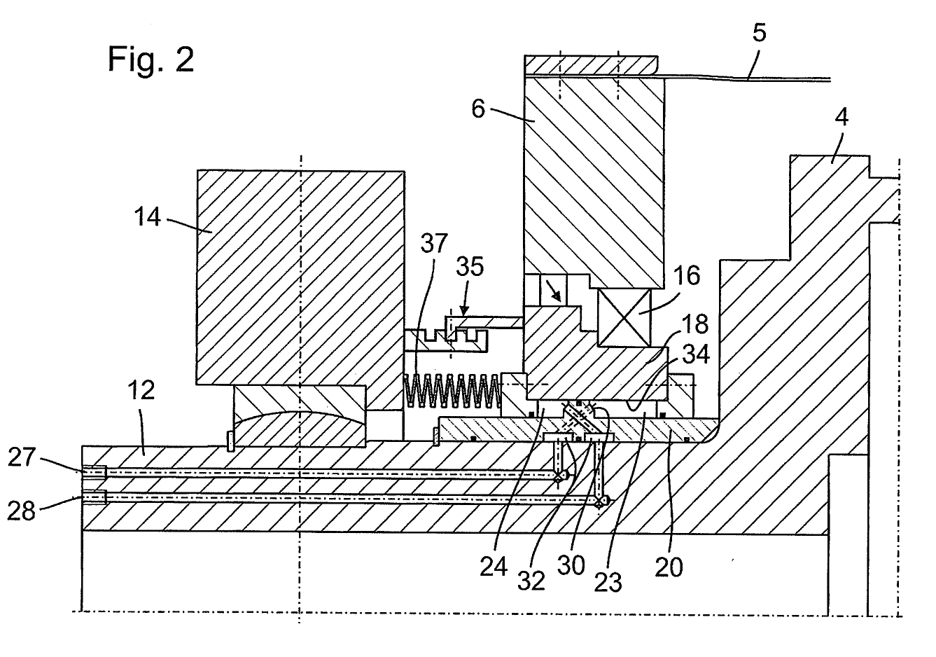

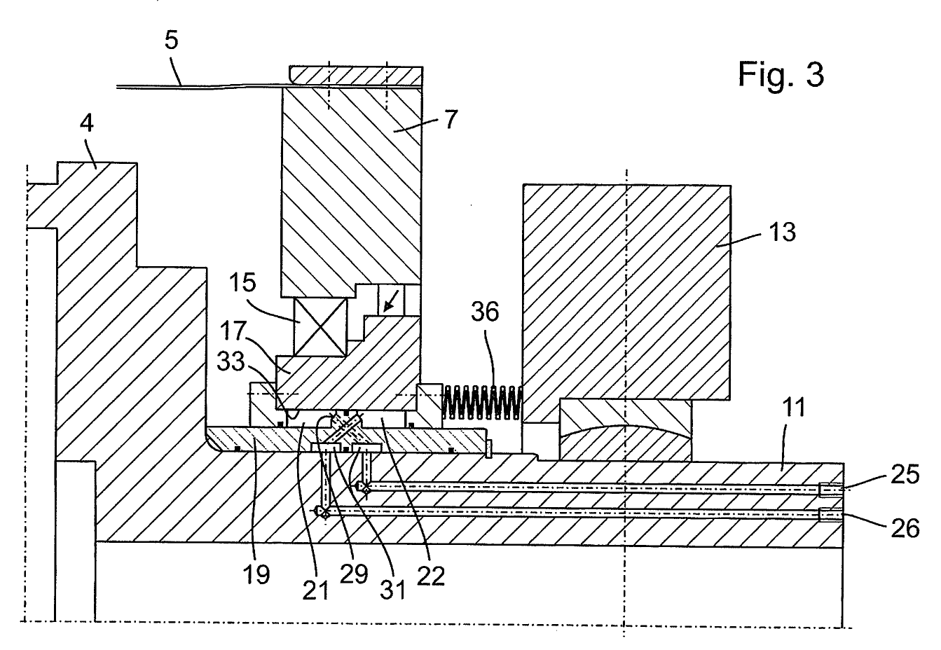

The bearing rings 17, 18, as illustrated in FIGS. 2 and 3, are mounted on bearing sleeves 19, 20 fixed to the supporting elements 4 such that they can be displaced axially. Bearing ring 17, 18 and bearing sleeve 19, 20 in this case each form an axially and double-acting cylinder/piston unit, whose pressure chambers 21, 22 and 23, 24 are connected to pressure lines 25, 26 and 27, 28 for the ability to move the bearing rings 17, 18 axially with respect to the bearing sleeves 19, 20 when pressure medium is applied.

The bearing sleeves 19, 20 in each case form a piston 29, 30 in the form of a radial extension, which seals off the two pressure chambers 21, 22 and 23, 24 from each other and via which the pressure lines 25, 26 and 27, 28, preferably led laterally, end in the pressure chambers 21, 22 and 23, 24. In addition, pressure medium chambers 31, 32 can be formed in the bearing sleeves 19, 20. The pistons 29, 30 interact with annular chambers 33, 34 which are in each case formed on the bearing ring 17, 18 and in which the two pressure chambers 21, 22 and 23, 24 are respectively formed.

By means of optionally applying pressure medium to the pressure chambers 21, 22 and 23, 24, the roll cover 5 can be tensioned and also moved axially.

In order to form a stationary rim disc 6, a locking device can additionally be provided which, according to FIG. 2, is formed by a latching device 35, for example, which, with a latching lug and latching bush, locks a displacement in discrete steps. Alternatively, locking in any desired positions can be provided.

Also preferably provided are springs 36, 37, which support the bearing ring 17, 18 with respect to the machine frame 13, 14 under spring prestress. The displacement of the bearing ring 17, 18 is damped and braked as a result.

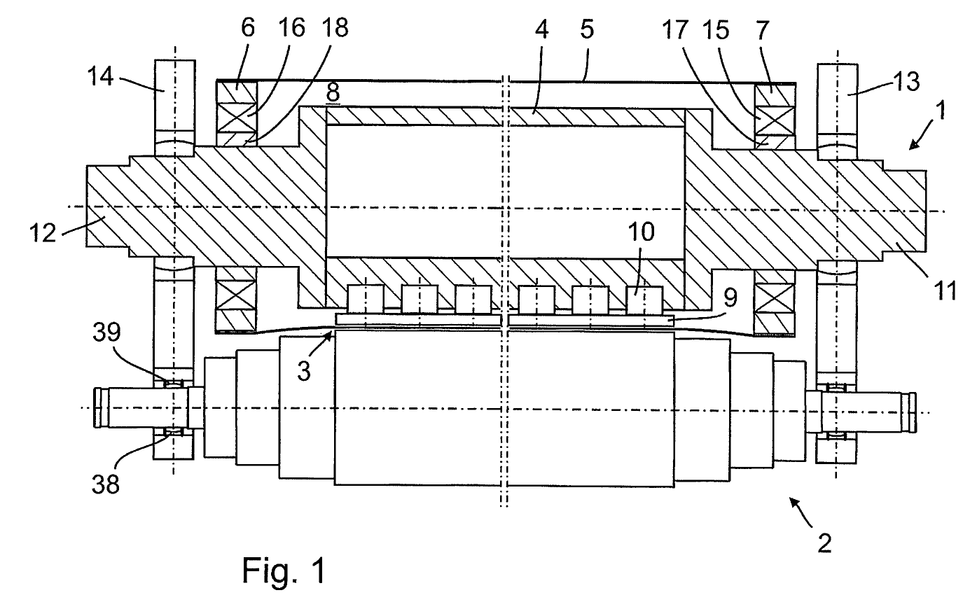

The mating roll 2 is constructed as usual, according to FIG. 1, and is rotatably mounted in the machine frame 13, 14 via bearings 38, 39.

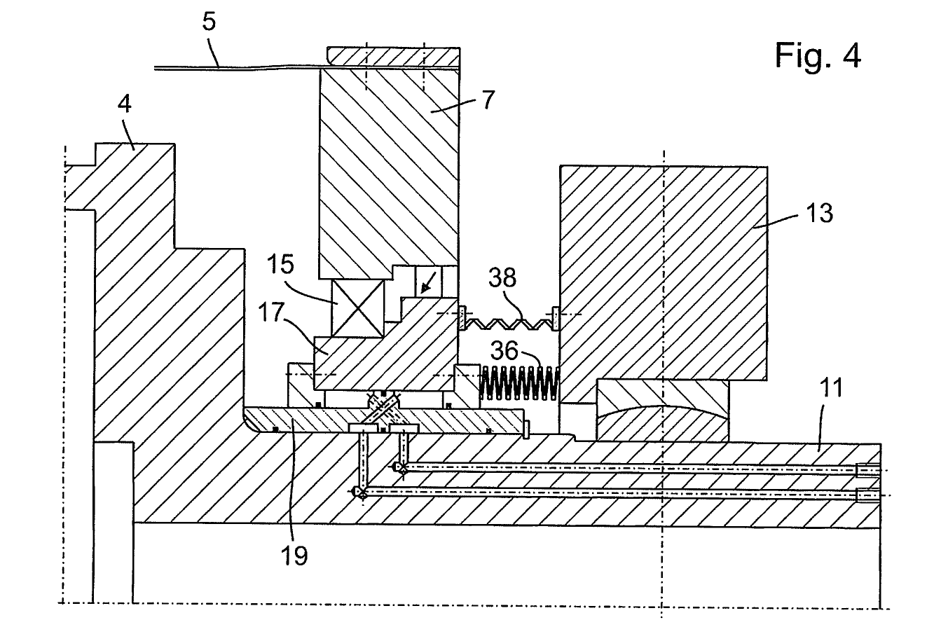

The second exemplary embodiment of the invention, illustrated in FIG. 4, differs from the exemplary embodiment described previously in the fact that the bearing rings 17, 18 and the machine frame 13, 14 are in each case connected via a sheath 38 which can be pulled out in the manner of an accordion. Accordingly, the sheath 38 forms a bellows which is able to follow the ability of the bearing rings 17, 18 to be displaced and, in the process, covers the movement path. The deposition of contamination on the movement path on the bearing sleeves 19, 20 is avoided as a result. The springs 36, 37, which can be formed as tension or compression springs, are additionally protected.

The use and the functionality of the sheath 38 is ensured in the same way when other means are used for tensioning the roll cover in the axial direction, as described in DE 33 17 455 or EP 0 527 881, for example.

All publications and patent applications mentioned in this specification are herein incorporated by reference to the same extent as if each individual publication or patent application was specifically and individually indicated to be incorporated by reference.

The invention now being fully described, it will be apparent to one of ordinary skill in the art that many changes and modifications can be made thereto without departing from the spirit or scope of the appended claims.

What is claimed is:

1. Apparatus for forming an extended nip between a mating roll and a shoe roll for treating a product web, in particular a paper web, the shoe roll having a stationary support and a flexible roll cover which can rotate around the support and which, in the region of the extended nip, is supported on a pressure shoe arranged on the support and whose ends are fixed on both sides in antifriction-mounted rim discs which are mounted via axially displaceable bearing rings on bearing sleeves fixed to the supporting element, wherein bearing sleeve and bearing rings in each case form an axially and double-acting cylinder/piston unit, whose pressure chambers are connected to pressure lines for an ability to move the bearing rings axially when pressure medium is applied.

2. Apparatus according to claim 1, wherein a piston is formed on the bearing sleeve and divides an annular chamber formed on the bearing into two pressure chambers.

3. Apparatus according to claim 2, wherein the pressure lines open into the pressure chambers via the piston.

4. Apparatus according to claim 3, wherein the pressure lines emerge laterally at the piston.

5. Apparatus according to claim 1, wherein, in order to construct a stationary rim disc, a locking apparatus is provided which fixes one of the bearing rings.

6. Apparatus according to claim 5, wherein the looking apparatus is designed to lock a bearing ring in discrete steps.

7. Apparatus according to claim 5, wherein the locking apparatus is designed to lock a bearing ring in any desired positions between two end positions.

8. Apparatus according to claim 1, wherein the bearing rings are arranged such that they can be moved axially counter to a spring prestress in order to develop incorporated damping.

9. Apparatus according to claim 8, wherein the spring prestress can be formed by a spring arranged between the respective bearing ring and a machine frame.

10. Apparatus according to claim 1, wherein the bearing ring and the machine frame are connected by a sheath that can be pulled out in the manner of an accordion.
